(19) United States
(12) Patent Application Publication
(10) Pub. No.: US 2018/0104854 A1
(43) Pub. Date: Apr. 19, 2018

(54) FLAT FAN SPRAYING APPARATUS FOR THE DISPENSING OF ULTRA-HIGH FAST SET TWO COMPONENT MATERIALS

(71) Applicant: Graco Minnesota Inc., Minneapolis, MN (US)

(72) Inventors: Steven R. Sinders, North Canton, OH (US); Benjamin D. Riley, Norton, OH (US); Michael P. Bozzelli, Akron, OH (US)

(21) Appl. No.: 15/787,256

(22) Filed: Oct. 18, 2017

Related U.S. Application Data
(60) Provisional application No. 62/409,686, filed on Oct. 18, 2016.

(51) Int. Cl. B29B 7/76; B29B 7/74; B05B 7/04

(52) U.S. Cl. CPC B29B 7/7615; B29B 7/761; B05B 7/2497; B05B 7/0408; B29B 7/7404; B29B 7/7452

(57) ABSTRACT

In an air-operated plural component mixing and dispensing assembly, including a sliding mixing and dispensing element that forms, with a pair of component inlet blocks, the valves controlling the mixing and dispensing of the plural component materials, the mixing and dispensing element includes a rearward part and a forward part which together form a mixing chamber, with admission passages for the plural components to be mixed in the rearward part and a dispensing orifice for mixed plural component material in the forward part, also including a shaping air assembly with an air inlet, a nozzle air manifold with internal air passageways to one or more impinging air outlets, wherein the shaping air assembly is configured to shape the spray pattern of the dispensed plural component material hydrostatically.

### CROSS-REFERENCE TO RELATED APPLICATIONS

This application claims priority to U.S. Provisional Application No. 62/409,686 filed Oct. 18, 2016, entitled “FLAT FAN SPRAYING APPARATUS FOR THE DISPENSING OF ULTRA-HIGH FAST SET TWO COMPONENT MATERIALS”, the disclosure of which are hereby incorporated by reference herein in their entirety.

### TECHNICAL FIELD

The present application relates generally to fluid dispensing, and in particular, apparatus for mixing and dispensing materials, including, for example, an air-operable gun for mixing and dispensing thermoplastic and thermosetting plural component materials, such as urethane foams and coatings, polyurea, catalyzed polyesters, catalyzed epoxies and other chemical compositions that react rapidly upon mixing of the components thereof.

### BACKGROUND

Polyurethane foam systems, for example, usually include component A, an isocyanate, and component B, a pre-formulated compound comprising a polyether resin, a catalyst, a surfactant and a blowing agent. Each component of the plural material is, by itself, generally stable, that is, each component does not cure or cross-link for several months or more, provided it is properly stored. However, mixing of component A and component B in proper concentrations initiates a chemical reaction that causes the components to begin to polymerize and generate heat which volatilizes the blowing agent and causes the polyurethane to foam, cure and cross-link. In one polyurethane system, water is used to combine with isocyanate to provide a carbon dioxide blowing agent; and in another polyurethane system, a fluorocarbon or Freon, which boils at about room temperature, provides the blowing agent. In this system, the blowing agent is trapped in the resin and acts in cooperation with the other constituents of the system to foam the polyurethane. Other systems may be such that the blowing agent is used to provide a cellular structure.

Usually cross-linking and curing of a plural component material is substantially completed in a matter of seconds. It is therefore desirable to mix the components in the dispensing device as close as is possible to the orifice from which the mix is ejected, that is, mixing of the several components of the compound should take place substantially contemporaneously with dispensing. Mixing the components of the plural component material with the dispensing device requires the apparatus operator to purge the residue of the mixed components from a mixing chamber and the orifice of the dispensing device so that the residue components do not chemically react and clog the chamber and the orifice, or in any other way prevent or inhibit dispensing of the plural component material.

Previously, the mixing and dispensing element—such as illustrated in FIGS. 1 & 2 from U.S. Pat. No. 7,527,172B2, which is incorporated by reference in its entirety—dispensed plural component materials in a consistently wide and uniform spray pattern (e.g., round pattern). This was done to effectively mix the plural components of the material and uniformly dispense the mixed plural component material in a wide, uniform and usable spray pattern. This round spray pattern of mixing for handheld and robotic spraying of ultra-fast and high-fasting two component materials was preferred due to its ability to stay cleaner in the exiting orifice and the surrounding exit surfaces. An off-ratio mixture of the plural components as a result of insufficient mixing and/or dispensing resulted in a mixed plural component lacking optimized properties, such as foam expansion, adhesion, etc. Further, off-ratio mixing of plural components may result in a mixed plural component that is dangerous to humans during dispensing.

Atomizing air streams are used for low pressure single stream materials that are easily manipulated. In high volume spraying applications, the velocity of the material exiting the orifice is so great that two impinging air streams don't have enough energy to flatten the spray pattern without massive volume of gas and/or extremely high pressures. Previously, a flat spray pattern with two component fast setting materials is generated using a mechanical structure to directly shape the spray pattern and then refine the pattern with air. This is done with a cats-eye type spray tip, but the problem with a cats-eye spray tip is that, when using ultra-fast setting two component materials, the trailing edges of the pattern results in poor material dispersion along the edge (e.g., the outside edges of the material are not clean due to such things as clumping, poor atomization, etc.). The mechanical solution requires the restrictive orifice of the stream to fully develop the spray pattern. However, this leads to the exiting orifice becoming clogged with the ultra-fast setting two component material.

For these aforementioned reasons, improvements to the mixing and dispensing element are desired.

### SUMMARY

According to at least one embodiment, a mixing and dispensing element generates a hydrostatically shaped pattern. The pattern is softened and/or widened with a minimal amount of impinging air stream(s), thus using less energy than traditional air atomizing guns. The softening and widening of the pattern also decreases the material thickness on the substrate by elongating the pattern along the impinging plane. The elongation of the spray pattern has the advantages of consistency of the thickness over length when compared to round and is sometime the preferred type of application.

According to at least one embodiment, a mixing and dispensing element generates a flat spray pattern without the use of a mechanical shearing spray tip.

According to another embodiment, a mixing and dispensing element includes a reciprocating mixing chamber that has communications with the ultra-fast setting two-component material and a purging source of high pressure gas, typically compressed air.

According to another embodiment, a mixing and dispensing element includes mixing chamber inlet ports that are in communication with a metered source of pressurized two-component material. The two materials may be introduced into a single exit orifice through two orifices that are perpendicular to the exit orifice.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

FIG. 1 is a cross-sectional view of a known plural component hand gun, taken at the vertical plane and in the direction indicated by line 1-1 of FIG. 2, in the non-dispensing position.

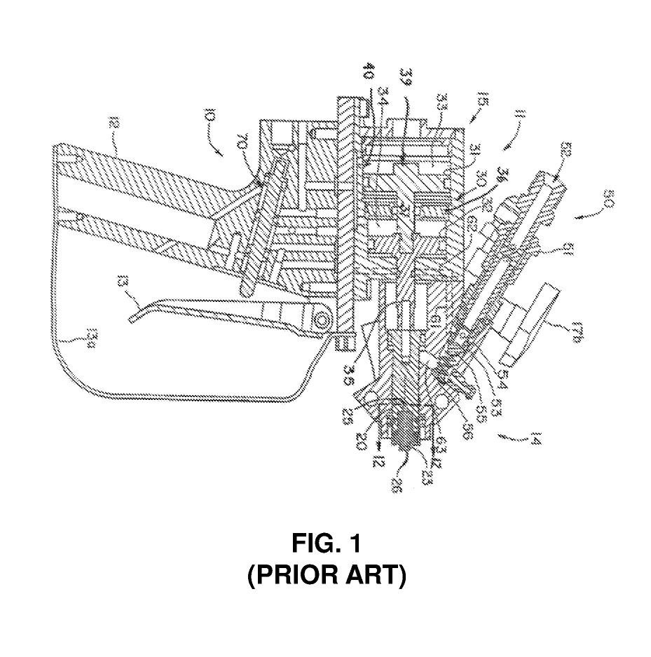

FIG. 2 is a view of the known plural component hand gun of FIG. 1, taken from the rear.

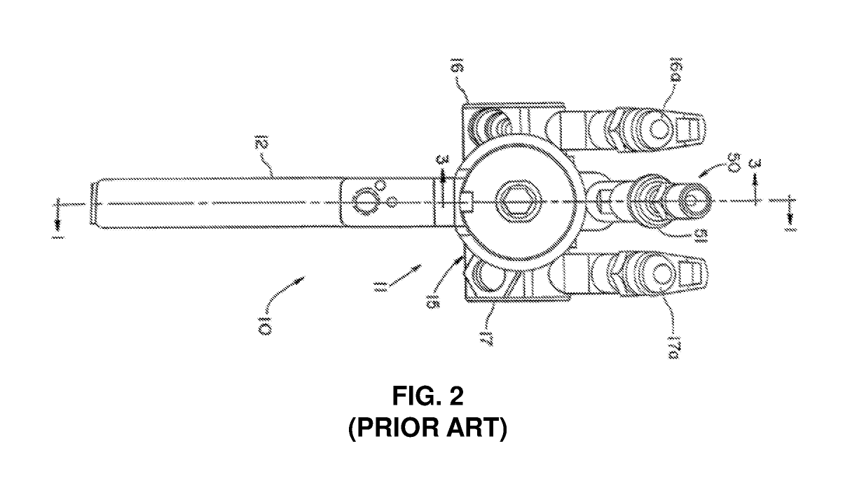

FIG. 3 is a perspective view of a plural component mixing and dispensing assembly according to at least two embodiments of the disclosure.

FIG. 4 is a perspective view of a nozzle of the plural component mixing and dispensing assembly in FIG. 3, according to at least two embodiments of the disclosure.

FIG. 5 is a cross-sectional view taken at the vertical plane (perpendicular to axis 23a) which illustrates the sealed interface between the plural component mixing and dispensing assembly and its connection blocks, according to at least two embodiments of the disclosure.

FIG. 6 is a cross-sectional view of the plural component mixing and dispensing assembly (parallel to axis 23a) illustrated in FIG. 3, according to at least two embodiments of the disclosure.

### DETAILED DESCRIPTION

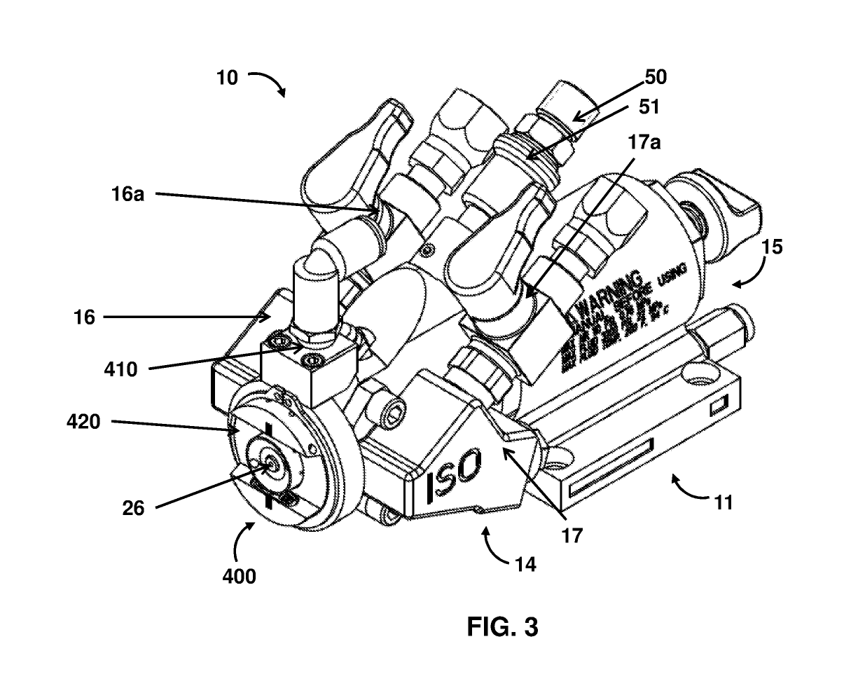

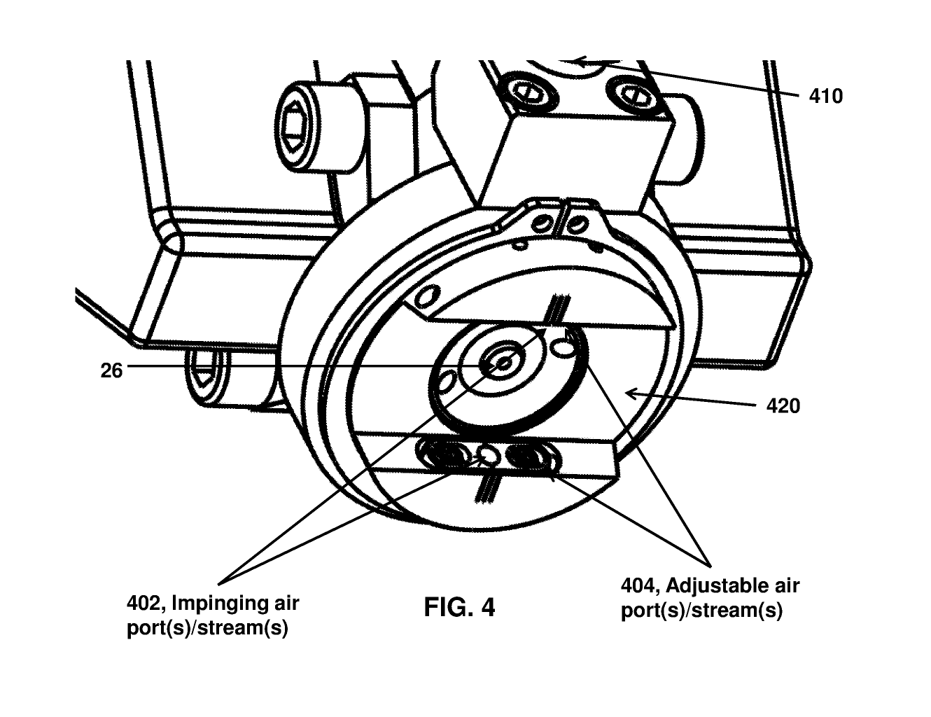

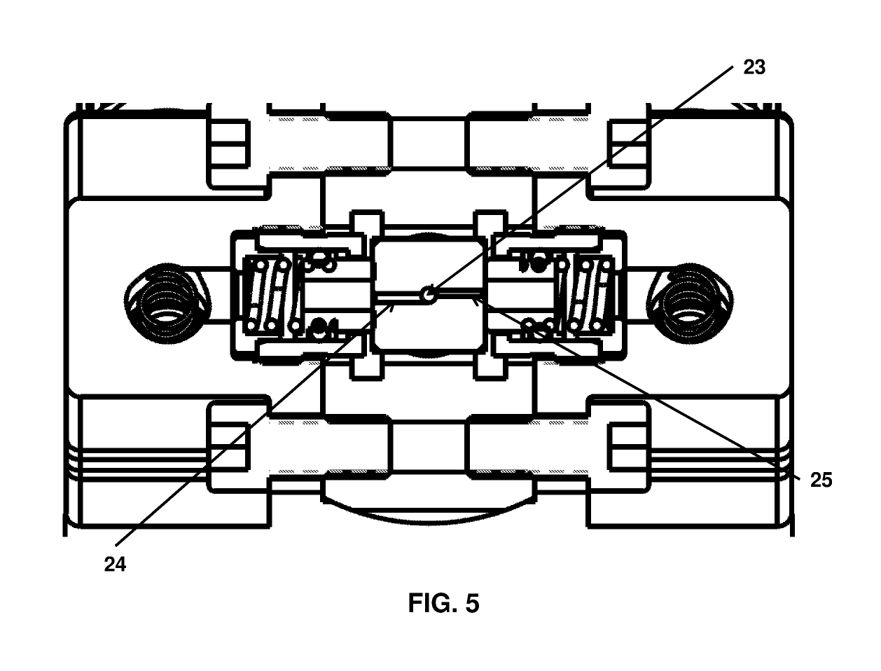

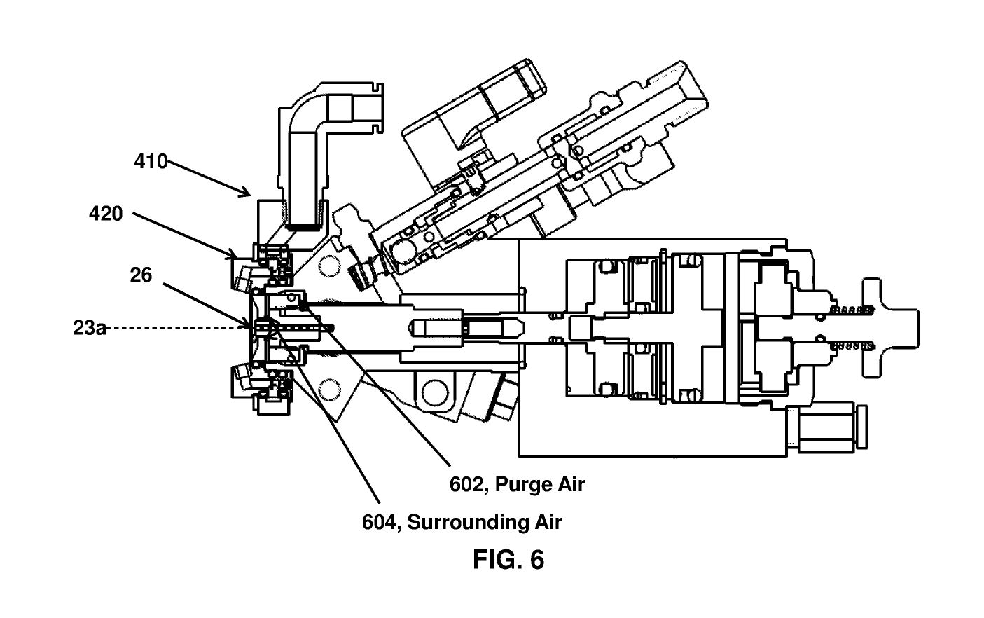

FIGS. 3-6 exemplify a plural component mixing and dispensing assembly 10 according to at least two embodiments of the invention. It should be understood that some embodiments may be designed for manual use (i.e., includes a handle and trigger assembly, such as a plural component dispensing hand gun embodiment), or alternatively, for mounted systems (i.e., lack a handle and trigger assembly), which include automated and robotic systems.

As indicated by FIG. 3, the plural component mixing and dispensing assembly 10 includes a housing 11. The housing 11 includes a connection portion 14 at its forward end and an actuator portion 15 at its rearward end. The words “forward” and “forwardly” in this description refer to the direction in which mixed plural component material is dispensed, and the terms “rearward” and “rearwardly” refer to the direction toward the back of the gun, the forward/rearward plane moving along and perpendicular to axis 23a. The connection portion of the housing 14 carries a pair of connection blocks 16 and 17. The connection blocks 16 and 17 provide connections for hoses that lead from the apparatus 10 to pressurized sources of each of the components of the plural component material. For example, connection block 16 carries a hose connection 16 a for a flexible hose leading to a source of component A of a plural component material, and connection block 17 carries a hose connection 17 a for a flexible hose leading to a source of component B of the plural component material. The connection blocks 16 and 17 can also carry valves 17 b and 16 b (not shown) to block the flow of the plural components to the outlets 18, 19 (not shown) of the connection blocks. The connection blocks 16 and 17 thus provide the inlets for each of the components of the plural component material to the plural component mixing and dispensing assembly 10, and are also sometimes referred to in this description as inlet blocks 16 and 17.

Compressed air delivered to the plural component mixing and dispensing assembly 10 through the air inlet 50 is put into a plurality of uses in the plural component mixing and dispensing assembly 10. When the valve 51 is in the “on” position, compressed air applied to the inlet end of the air inlet 50 is present at a first opening downstream of the on/off valve 51, and can flow through air passageways formed respectively in the connection portion 14 and actuator portion 15 of the housing 11.

Plural component mixing and dispensing assembly 10 includes shaping air assembly 400. Shaping air assembly 400 includes and air inlet 410 and a nozzle air manifold 420, which includes internal air passageways to impinging air outlet(s) 402 and/or adjustable air outlet(s) 404. Thus, nozzle air manifold 420 allows outlet(s) 402 and/or 404 to be positioned in any 360 degree array around dispensing nozzle 26. Air assembly 400 provides the impinging air stream(s) and/or adjustable air stream(s) necessary to shape the plural component material exiting at nozzle 26.

The plural component mixing and dispensing assembly uses a reciprocating mixing chamber 20 that has communications with the ultra-fast setting two-component material and a purging source of high pressure gas, typically compressed air. When in the dispensing position, the mixing chamber inlet ports are in communications with a metered source of pressurized two-component material. These two materials are introduced into a single exit orifice through two orifices that are perpendicular to the exit orifice. The two orifices that communicate the two component materials are typically the same size, but can vary slightly and represent a restriction that can be used to control flow. The area of the cross section of assembly passages 24 and 25 are substantially equal to the area of the mixing chamber (exit port) 23 (i.e., Area of 24+Area of 25=Area of 23, or within 30%, as a percentage of area). Assembly passages 24 and 25 are machined to be tangent with the center plane of the chamber 23 (exit orifice). Since chamber 23 is slightly larger then each of cross sections of assembly passages 24 and 25, an offset in assembly passages 24 and 25 results when machined perpendicular to chamber 23. The plural component materials are introduced at high pressures into the reciprocating mixing chamber, and the collision in chamber 23 creates turbulences that assist in the atomization of the mixture exiting the dispensing nozzle 26. The hydrostatically generated pattern from this mixing is considered to be a round spray pattern. When the two orifices are in communication with the purging source, the materials from 24 and 25 are purged from the mixing chamber with the high pressure gas.

Shaping air assembly 400 turns the hydrostatically generated two component spray pattern into a flat spray pattern. The invention utilizes the purge air 602 to surround the exiting material when dispensing, but (in most embodiments) the purge air 602 shuts off during the purging phase. The surrounding air 604 may soften the round spray pattern, but is predominately used to prevent the formation of eddies that are generated from the two impinging air streams. In many embodiments, the impinging air port(s) 402, providing impinging air stream(s) are located on a 105 degree angle from axis 23a. In alternative embodiments, the degree angle range from 75 degrees to 135 degrees from axis 23a. In the illustrated embodiment, two impinging air streams are provided. In most embodiments, the horizontal plane of the exiting stream impinges roughly 0.240″ from the exiting nozzle. In most embodiments, the impinging air port(s) are adjustable and move with the horizontal plane of the exiting material stream. This adjustability allows for the impinging air streams to move from either side of the vertical exiting material stream plane. Since this round spray pattern is hydrostatically generated, variation in the centerline of the material stream has been noticed and moveable, impinging air streams allow for this variation. Without being bound by theory, it believed that chamber 23 needs to be highly polished with no tool marks or drilling rotational mark on the inside surface. In some embodiments, additional adjustable shaping air port(s) 404 are provided air stream(s) to further shape and/or improve the dispersion qualities of the dispensed plural component material.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

In some embodiments, some component(s) or step(s) may be omitted for optimizing design, function, economy, or any combination thereof, and therefore, the omission of any such component(s) or step(s) shall be a negative limitation, if so claimed.

To the extent that any definitions, limitations, descriptions, preferred features, or preferred configurations provided in the instant Specification conflict with any part of U.S. Pat. No. 7,527,172B2 (which has been incorporated by reference in its entirety) the definitions, limitations, descriptions, preferred features, and preferred configurations in the instant Specification control.

The present disclosure is made using various embodiments to highlight various inventive aspects. Modifications can be made to the embodiments presented herein without departing from the scope of the invention. As such, the scope of the invention is not limited to the embodiments disclosed herein.

What is claimed is:

1. A plural component mixing and dispensing assembly for dispensing a plural component material, comprising:
a housing including a connection portion at its forward end and an actuator portion at its rearward end;
a mixing and dispensing element formed with opposed planar side portions, an unobstructed air purgeable cylindrical mixing chamber within the element between the planar side portions, a pair of cylindrical admission passages, with one cylindrical admission passage extending between each of the planar side portions and the mixing chamber, and a dispensing orifice in communication with the mixing chamber at the forward end of the mixing and dispensing element, said mixing and dispensing element being slidably carried by the connection portion of the housing;
a connection block for each of the plural components carried by the connection portion of the housing, one connection block being carried on each side of the connection portion of the housing with a side surface interfacing with a planar side portion of the mixing and dispensing element, each connection block providing means for connecting a supply of one of the plural components with the mixing chamber of the mixing and dispensing element and including an internal supply passageway leading to an outlet opening in its side surface, the side surface of each of said connection blocks carrying a seal element around its outlet opening that slidably engages the interfacing planar side portion of the mixing and dispensing element and seals the interface between the connection block and the mixing and dispensing element; and
an air-operated actuator carried by the actuator portion of the housing for sliding the mixing and dispensing element with respect to the connection portion of the housing between a rearward position at which the admission openings of the mixing and dispensing element communicate with the outlet openings of the connection blocks, permitting a flow of the plural components into the mixing chamber for mixing and dispensation, and a forward position at which the outlet openings of the connection blocks are blocked by the planar side portions of the mixing and dispensing element and the admission openings are located to provide a purging flow of air through the mixing chamber and dispensing orifice;
a shaping air assembly, further including an air inlet, a nozzle air manifold with internal air passageways to one or more impinging air outlets, wherein the shaping air assembly is configured to shape the spray pattern of the dispensed plural component material hydrostatically.

2. The plural component mixing and dispensing assembly of claim 1, wherein the shaping air assembly shapes the dispensed plural component material using shaping air from one or more impinging air ports.

3. The plural component mixing and dispensing assembly of claim 2, wherein the shaping air assembly shapes the dispensed plural component material using shaping air from one or more adjustable shaping air ports.

4. The plural component mixing and dispensing assembly of claim 1, wherein the shaping air assembly shapes the dispensed plural component material without a mechanical structure shape the spray pattern by direct contact.
